(19) United States
(12) Patent Application Publication
(10) Pub. No.: US 2025/0327374 A1
(43) Pub. Date: Oct. 23, 2025

(54) SPECIALIZED TREATMENT OF BIOFILMS FOUND IN RELIEF WELLS OF DAMS AND LEVEES USING CHLORINE GAS INFUSION

(71) Applicant: U.S. as Represented by The Secretary of The Army, Alexandria, VA (US)

(72) Inventors: Clint Brian Smith, Chantilly, VA (US); Ilea Adelina Diaz-Lluberes, Annandale, VA (US); Catherine Corte Thomas, Terry, MS (US); Edith Lorena Martinez-Guerra, Vicksburg, MS (US); Osvaldo Alomar, Chambersburg, PA (US); Jillian Dees Dalton, Vicksburg, MS (US)

(21) Appl. No.: 18/643,875

(22) Filed: Apr. 23, 2024

(51) Int. Cl. E21B 37/06; B01F 23/23; B01F 23/232; B01F 23/40; B01F 23/451; B01F 25/53; B01F 35/21; B01F 35/22; B01F 101/49

(52) U.S. Cl. CPC E21B 37/06; B01F 23/2319; B01F 23/2323; B01F 23/451; B01F 23/483; B01F 23/49; B01F 25/53; B01F 35/2132; B01F 35/2202; B01F 2101/49

(57) ABSTRACT

In one embodiment, a method for treating one or more wells comprises: combining a liquid concentrated chlorine bleach with water on-site at the one or more wells; generating gaseous chlorine on-site; adding the gaseous chlorine into the water combined with the liquid concentrated chlorine bleach to produce a field treating solution on-site; and delivering the field treating solution into the one or more wells.

### STATEMENT OF GOVERNMENT INTEREST

Under paragraph 1 (a) of Executive Order 10096, the conditions under which this invention was made entitle the Government of the United States, as represented by the Secretary of the Army, to an undivided interest therein on any patent granted thereon by the United States. This and related patents are available for licensing to qualified licensees.

### CROSS-REFERENCE TO RELATED APPLICATIONS

### BACKGROUND

### Field of the Invention

The present invention relates to systems and methods of cleaning wells and, more specifically, to systems and methods for treating biofouling in relief wells.

### Description of the Related Art

This section introduces aspects that may help facilitate a better understanding of the invention. Accordingly, the statements of this section are to be read in this light and are not to be understood as admissions about what is prior art or what is not prior art.

Pressure relief wells relieve subsurface hydrostatic pressures which may develop within the pervious foundations of dams, levees, and hydraulic structures. All water retention structures are subject to seepage through their foundations and abutments. In many cases the seepage may result in excess hydrostatic pressures or uplift pressures beneath elements of the structure or landward strata. Relief wells are often installed to relieve these pressures which might otherwise endanger the safety of the structure. Relief wells, in essence, are nothing more than controlled artificial springs that reduce pressures to safe levels and prevent the removal of soil via piping or internal erosion.

Fouling in relief wells is chiefly attributed to chemical (“cementation or incrustation”) and biological (“biofouling”) action. The most commonly reported chemical incrustations are calcium carbonates, iron (iron oxyhydroxides and iron sulfides), manganese hydroxides, and products of decomposition from lignite beds. Biofouling is most commonly caused by iron-, manganese-, and/or sulfur-oxidizing bacteria; these organisms are present in some concentrations in nearly all shallow-depth freshwater wells in North America and their abundance is a function of environmental conditions including oxidation-reduction potential (ORP or Eh), pH, temperature, and dissolved concentrations of iron and other substances.

Physical fouling, such as “silting in,” may also occur, and results when very fine material migrates into the filter material, clogging it or reducing its conductivity; this may be caused by improper or incomplete well development, bridging of filter material during installation and subsequent separation, extreme over-pumping, or incorrect filter design. This mechanical contamination of relief wells by silts, clays, or other particulate media entering the filter pack either from the formation or through the top of the well is usually difficult to determine except as indicated by periodic pumping tests.

Chemical incrustation of the well screen, filter pack, and surrounding formation soils can be a major factor in specific capacity reduction with time. Chemical deposits within the screen openings reduce their effective open area and cause increased head losses. Deposits in the filter pack and surrounding soils reduce their permeability and also increase head losses. The occurrence of chemical incrustation is determined chiefly by water quality. The type and amount of dissolved minerals and gases in the water entering the well determine the tendency to deposit mineral matter as incrustations. Common indicators of incrusting waters are: pH>7; total Fe>2 ppm; total Mn>1 ppm in conjunction with high pH and presence of O₂; and total carbonate hardness >300 ppm.

Relief Well biofouling build out has been shown to build unwanted pressure within dams/levees when left untreated. Built up pressure can lead to dam/levee failure. Current methods of treatment involve using potentially harmful and toxic chemicals. The most common technique for controlling relief wells that are incorporated into the infrastructure of dams and levees in the field involves treatment with oxalic acid to alleviate hydrostatic pressures when encrusted biofouling occurs. When encrusted biofilms are chemically treated and broken up, the relief wells are relieved of pressures that can build up in the dams or levees foundation infrastructure.

U.S. Pat. No. 11,731,894 discloses a mobile water treatment system. The system includes a mobile framework, one or more treatment modules mounted on the mobile framework, and a piping system in fluid communication with the one or more treatment modules. The piping system includes one or more pumps to convey water to and from the one or more treatment modules, and at least one power source to provide power to the one or more pumps and the one or more treatment modules. The treatment modules may include pre-filtration, chlorination treatment that generates chlorine by electrolysis, activated carbon treatment, and treatment using a disinfecting, silver coated composite material. A quick connecting water distribution manifold system is connected to the mobile framework, selectively enabling fluid communication with and through the one or more treatment modules. A manifold directs recirculated chlorinated water to and from a bladder tank prior to release as sanitized chlorinated water.

### SUMMARY

The present invention was developed to address the desire for a safe and a more efficient, effective, and economically feasible way of addressing biological and chemical fouling in wells.

Field experiments continue to understand chemistry & physics of relief well biofouling & encrustation treatments and new treatment protocols. New treatment methods/logistical approaches have been conducted involving chlorinated gas infused water and liquid bleach production.

Biofilms in relief wells are more challenging to disinfect and/or inactivate than planktonic organisms. Biofilms are highly organized 3D structures where microorganisms are embedded in a self-produced complex matrix made of extracellular polymeric substances. For example, free-swimming bacteria can reversibly attach to different types of surfaces as planktonic bacteria. The bacteria transition from reversible to irreversible attachment due to EPS (extracellular polymeric substances) production in an auto-aggregation process. Early development of biofilm architecture results in a stable supercellular structure. Later development of micro-colonies results in growth where secondary colonization by multiple species can occur. Mature biofilms are characterized by complex 3D structures. Extracellular polymeric substances (EPS) are protective against many chemical treatments.

Embodiments of the invention provide methods and systems for treatment of relief wells for dams and levees and wells in general. A new technique is used for treating relief wells for biofouling in dams and levees operation. The Relief Well Sustainment (RWS) Deployable Resilient Installation water Purification and treatment System (DRIPS) RWS-DRIPS project is directed to a state-of-the-art bleach gas infusion generator and pumping system that can produce both liquid bleach and/or chlorine gas infused water. The system utilizes table salt and water to produce high concentration bleach for biofouling treatment. Washable membranes allow for durable and easy physical filtrations of particulate. Its valve and hose system allows for it to be easily attached to multiple containers with the provided adapters. The RWS-DRIPS unit weighs less than 500 pounds, fits in the back of a pickup truck or trailer, and is considered a 2-person lift. The unit is powered with a dual fuel generator (propane and gasoline), 110 VAC, 12 VDC deep cycle marine battery with solar panel recharge capability, and the ability to be plugged into a generator or vehicle for power.

The RWS Systems include a mobile cart with a framed treatment train including dual fuel power supply, pumps, filtration, bleach generation, and water production for providing drinkable water and recirculation for concentrating the chlorine gas infused water for encrusted biofilm treatment. The new process provides new treatment processes for field designed protocols to provide improved risk management for relief well treatments impacting dam & levee infrastructure.

In some embodiments, a towable trailer is integrated with an RWS-DRIPS unit and a 1000-gallon storage tank for treating relief wells, based on the novel formulation of gas infused chlorination or bleach treatment of the wells. The addition of chlorine infused water (bleach) treatment for field design protocols helps improve the relief well risk management to dams and levees, which in turn reduces the cost, time, and manpower required to control relief well biofouling and encrustation.

According to an aspect the present invention, a method for treating one or more wells comprises: combining a liquid concentrated chlorine bleach with water on-site at the one or more wells; generating gaseous chlorine on-site; adding the gaseous chlorine into the water combined with the liquid concentrated chlorine bleach to produce a field treating solution on-site; and delivering the field treating solution into the one or more wells.

In some embodiments, the method further comprises providing the liquid concentrated chlorine bleach in a pre-concentration storage on-site, and flowing the liquid concentrated chlorine bleach from the pre-concentration storage to a storage tank to be combined with the water in the storage tank. At least some of the liquid concentrated chlorine bleach may be prepared offsite in advance and brought to the one or more wells to be combined with the water on-site. The method may further comprise producing, on-site, at least some of the liquid concentrated chlorine bleach which is to be combined with the water on-site. At least some of the liquid concentrated chlorine bleach may be produced by applying electric energy to an ionic source of chlorine and water on-site.

In specific embodiments, the method further comprises adding the gaseous chlorine into the water combined with the liquid concentrated chlorine bleach to produce the field treating solution on-site at a preset nominally aqueous chlorine concentration before delivering the field treating solution into the one or more wells. The method may further comprise recirculating the field treating solution from the storage tank to the pre-concentration storage on-site to adjust the nominally aqueous chlorine concentration of the field treating solution in the storage tank to achieve the preset nominally aqueous chlorine concentration.

In some embodiments, the method comprises, after delivering the field treating solution into one well of the one or more wells and before delivering the field treating solution into another well of the one or more wells, adjusting the nominally aqueous chlorine concentration of the field treating solution in the storage tank by performing at least one of: adding water to the field treating solution in the storage tank on-site; adding the liquid concentrated chlorine bleach to the field treating solution in the storage tank on-site; adding the gaseous chlorine to the field treating solution in the storage tank on-site; or recirculating the field treating solution from the storage tank to the pre-concentration storage on-site. The method may further comprise monitoring an aqueous chlorine concentration of the field treating solution until a preset aqueous chlorine concentration is reached before delivering the field treating solution into the one or more wells.

In accordance with another aspect of the invention, a method for treating one or more wells comprises: providing a liquid concentrated chlorine bleach in a pre-concentration storage on-site at the one or more wells; combining the liquid concentrated chlorine bleach from the pre-concentration storage with water in a storage tank on-site; generating gaseous chlorine on-site; adding the gaseous chlorine into the water combined with the liquid concentrated chlorine bleach in the storage tank to produce a field treating solution on-site; and delivering the field treating solution into the one or more wells.

In some embodiments, the method further comprises, before delivering the field treating solution into a well of the one or more wells, adjusting an aqueous chlorine concentration of the field treating solution in the storage tank by performing at least one of: adding water to the field treating solution in the storage tank on-site; adding the liquid concentrated chlorine bleach to the field treating solution in the storage tank on-site; adding the gaseous chlorine to the field treating solution in the storage tank on-site; or recirculating the field treating solution from the storage tank to the pre-concentration storage on-site.

In accordance with yet another aspect, a system for treating one or more wells comprises: a supply of a liquid concentrated chlorine bleach on-site at the one or more wells; a gaseous chlorine generator to generate gaseous chlorine on-site; a storage tank; and a plumbing system to flow the liquid concentrated chlorine bleach from the supply of the liquid concentrated chlorine bleach and the gaseous chlorine from the gaseous chlorine generator to the storage tank to be combined with water in the storage tank on-site, to produce a field treating solution on-site to be delivered into the one or more wells.

In some embodiments, the system further comprises a pre-concentration storage to store the liquid concentrated chlorine bleach on-site. The plumbing system is coupled with the pre-concentration storage to flow the liquid concentrated chlorine bleach from the pre-concentration storage to the storage tank on-site. The system may comprise a recirculation flow line configured to recirculate the field treating solution from the storage tank to the pre-concentration storage on-site to adjust an aqueous chlorine concentration of the field treating solution in the storage tank.

In specific embodiments, the system further comprises a liquid concentrated chlorine bleach generator to produce the liquid concentrated chlorine bleach on-site to a target bleach concentration; and a data processor configured with software that calculates and controls an energy power level to operate the liquid concentrated chlorine bleach generator based on the target bleach concentration.

In some embodiments, the system further comprises at least one of: one or more containers which contain the liquid concentrated chlorine bleach prepared offsite and are brought on-site; or a liquid concentrated chlorine bleach generator to produce the liquid concentrated chlorine bleach on-site. The liquid concentrated chlorine bleach generator is configured to produce at least some of the liquid concentrated chlorine bleach by applying electric energy to an ionic source of chlorine and water on-site.

### BRIEF DESCRIPTION OF THE DRAWINGS

Embodiments of the invention will become more fully apparent from the following detailed description, the appended claims, and the accompanying drawings in which like reference numerals identify similar or identical elements.

FIG. 1 shows an example of an environment in which a Water On Wheel (WOW) Cart-Relief Well Sustainment (RWS) Deployable Resilient Installation water Purification and treatment System (DRIPS) unit operates.

FIG. 2 is a schematic illustration of an example of an RWS-DRIPS unit having a mobile platform.

FIGS. 3A and 3B illustrate side and top schematic views, respectively, of an example of a high concentration bleach generator.

FIG. 4A shows a front angled view and FIG. 4B shows a side view, as an alternative embodiment, of a chlorine generator probe used to produce a concentrated chlorine solution.

FIG. 5 is a schematic view illustrating an example of a high concentration bleach generator system.

FIG. 6 is a graphical plot of an example of a calibration curve of absorption versus total chlorine concentration.

FIG. 7 is a graphical plot of an example of calculated chlorine demand in a relief well (RW) sample in the laboratory.

FIGS. 8A and 8B show a table of results from the field.

FIG. 9 is a perspective view of a rendered model of an RWS-DRIPS trailer unit.

FIG. 10 is another perspective view of the rendered model of the RWS-DRIPS trailer unit.

FIG. 11 is another perspective view of the rendered model of the RWS-DRIPS trailer unit.

FIG. 12 is a top plan view of the rendered model of the RWS-DRIPS trailer unit.

FIG. 13 is a close-up perspective view of the rendered model of the RWS-DRIPS unit illustrating the electrochlorination treatment train and pumps with hose connections to the pre-spike concentration container and the 1000-gallon tank.

FIG. 14 is close-up top plan view of the rendered model of the RWS-DRIPS unit illustrating the electrochlorination treatment train and pumps with hose connections to the pre-spike concentration container and the 1000-gallon tank.

FIG. 15 is a flow diagram illustrating an example of a process for treating biofouling in a relief well.

### DETAILED DESCRIPTION

Detailed illustrative embodiments of the present invention are disclosed herein. However, specific structural and functional details disclosed herein are merely representative for purposes of describing example embodiments of the present invention. The present invention may be embodied in many alternate forms and should not be construed as limited to only the embodiments set forth herein. Further, the terminology used herein is for the purpose of describing particular embodiments only and is not intended to be limiting of example embodiments of the invention.

As used herein, the singular forms “a,” “an,” and “the,” are intended to include the plural forms as well, unless the context clearly indicates otherwise. It further will be understood that the terms “comprises,” “comprising,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

When a well cannot meet its design flow rate, it may require rehabilitation, a process that has been estimated to cost in the vicinity of $6,000-$24,000 per well ($3,000-$12,000 in 1995 dollars) depending on well diameter, depth, and degree of fouling. This process is entirely manual, potentially dangerous to personnel depending on the treatment method employed (e.g., hazardous chemicals), and often short-lived—it is common for well performance improvements to deteriorate as recolonization or regrowth occurs in weeks to months.

One feature of the present invention is to reduce cost, increase efficacy, and improve safety through the use of a better formulation of gas infused chlorination or bleach for remediation and treatment of biological and chemical fouling in wells.

The technique involves deploying an added UVC into the well for no invasive exposure and treatment follow up. Protocol design knowledge was collected and integrated into preliminary laboratory test and subsequently field protocols to understand maximizing the pH and concentration to effectively treat the encrusted biofilms with chlorine infused water (bleach). A UVC attachment/deployable unit is paired with the RWS system. Testing has been conducted to better understand the use of the bleach treatment with UVC design protocols.

The current treatment methods use oxalic acid versus chlorine gas infused water and bleach to establish initial treatments. The demonstrations are aimed at improving preventative relief well treatment. The effort is seeking to embed the RWS mounted onto a trailer and 1000 gallon holding tank mobile unit to aid in treating multiple relief wells by the operational teams' standards. The addition of pre/post-treatment with UVC before/after chlorine gas infused water and/or bleach is investigated. A novel plasma technology for water is tested. Data collection and post analysis assist in establishing new design treatment protocols and physical set up for the treatment process by field engineers. Data collected helps determine overall efficiency and limitations.

Relief well biofouling and encrustation knowledge leads to reducing exposure time/manpower (2-person team)/treatments to dams/levees saving. With salt as base reagent it is estimated that $5.49M ROI over life cycle of 100 years for Relief Well treatment. Improved treatment deployment to save time (pre-treatment planning and in field treatment process) hours/manpower (2-person) operation/treatment source table salt $0.30 versus oxalic acid $1.00 cost per pound. Impact on implementing the RWS-DRIPS technology will save lives, provide low maintenance treatment, cost savings $109.99 to treat each relief well with salt ($0.0042) versus Oxalic Acid ($110.00) (100 RWs: Savings $10,999.58), & time (Treatment of 20 wells/day). The present method which utilizes the equipment as one part/step of a broader approach saves extensively in cost/materials/time of treatment, etc.

Dual use of the RWS-DRIPS unit is that it can disinfect source water supplies such as water from reservoirs and provide clean drinkable or potable water for a community of on average 800 to 1000 people in a disaster scenario-humanitarian assistants and disaster relief. The 1000-gallon tank can be used to help store and distribute the water when needed if that situation occurs.

The present invention provides a fast, easy way to deploy treatment for relief wells, saving time, manpower, and money. It improves risk assessment for levees and dams. It improves understanding of the underlying chemistry and physical drivers for biofouling and encrustation control for treatment and sustainment. It reduces unnecessary project modifications of chemical supply and use.

The present approach substitutes a chlorine-based treatment for an acid-based treatment. The chlorine-based treatment has two components. The first involves a “kick start” step to “pre-spike” the field treating solution by taking for the basic chlorine charge the output of a device that takes an ionic source of chlorine (such as dry salt) and applying electric energy (with water) to generate a chlorine containing bleach. The second involves a “topping” step to add as a “topper” a gaseous chlorine output (e.g., from an off-the-shelf device such as the M−100) to the chlorine containing bleach to produce the desired endpoint of nominally 5,000 ppm aqueous chlorine concentration. This unique approach both (i) attains the 5,000 ppm+ level and (ii) achieves that level far more quickly than previously possible.

In specific embodiments, the method combines the “pre-spike” chlorine bleach materials obtained from salt and the “topper” chlorine gaseous materials from the COTS (commercial-off-the-shelf) M−100 unit to obtain 1,000 gals of 5,000 ppm chlorine treatment materials in a short period of time and on location. The result is an amount that may be sufficient to treat 15-20 (or more) relief wells without having to recharge the 1,000-gal treatment tank.

One objective of the present invention is to field generate 1,000 gals of chlorine-based well treatment material good for treatment of on the order of at least 15-20 relief wells without stopping at 2-3 well intervals to remix (as the old acid-based method requires). The novel field treatment method achieves the objective by combining the “kick start” and “topping” steps that drastically reduces the time, expense, labor, etc.

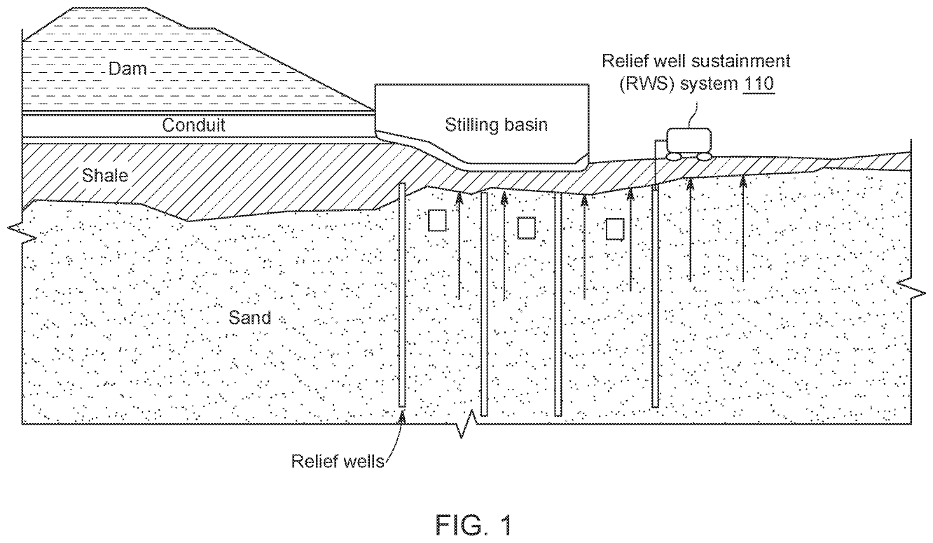

FIG. 1 shows an example of an environment in which a Water On Wheel (WOW) Cart-Relief Well Sustainment (RWS) Deployable Resilient Installation water Purification and treatment System (DRIPS) unit 110 operates. The RWS-DRIPS unit 110 produces and delivers a chlorine-based well treatment material to the relief wells. The relief wells extend from the shale into the sand below. A stilling basin is disposed at the edge of a dam and a conduit. Advantageously, the RWS-DRIPS unit 110 is mobile and is configured to produce rapid chlorination of the water treatment material to treat multiple wells effectively and efficiently.

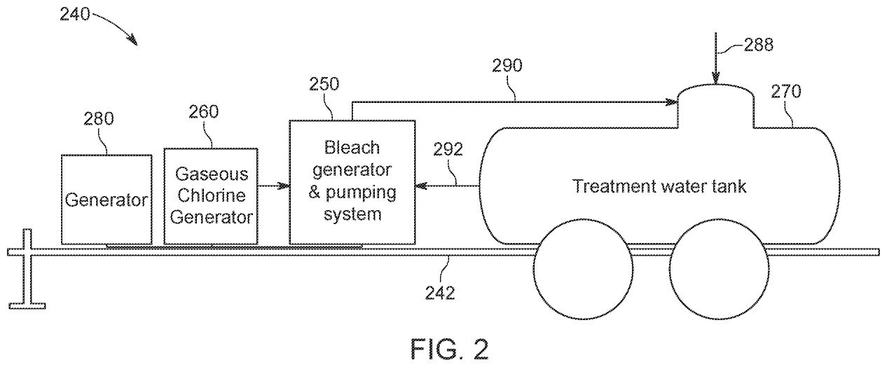

FIG. 2 is a schematic illustration of an example of an RWS-DRIPS unit 240 having a mobile platform. The DRIPS unit is the USACE-ERDC developed term for the WOW cart. The RWS-DRIPS unit 240 is designed as a new alternative to mitigate encrusted biofilms by producing bleach from salt and water, for instance, by electrochlorination. It includes a state-of-the-art bleach generator and pumping system 250 that can produce both liquid bleach and chlorine gas infused water. The bleach generator and pumping system 250 is used to “pre-spike” the field treating solution with a high concentration chlorine containing bleach. A gaseous chlorine generator 260 is configured to produce a concentrated solution of gaseous chlorine. An example of the gaseous chlorine generator 260 is a COTS M-100 chlorine generator that uses a 12-volt car battery or power supply and salt to produce chlorine gas simply and safely, which can then be injected as a “topper” into a solution. The bleach generator and pumping system 250 combines the pre-spike chlorine bleach material with the gaseous chlorine from the gaseous chlorine generator 260 as a topper to produce a field treating solution of a certain nominally aqueous CI concentration. The target aqueous CI concentration may be nominally 4000-6000 ppm, or 4500-5500 ppm, or about 5000 ppm (e.g., +5%).

The system utilizes table salt and water to produce the high concentration bleach for biofouling treatment. Washable membranes allow for durable and easy physical filtrations of particulate. Its valve and hose system allows for it to be easily attached to one or more containers or storage tanks 270 with the provided adapters. In an example, the system 240 includes a 1000-gallon storage tank 270. A water line 288 with a water line valve supplies water into the storage tank 270. The unit is powered with a dual fuel generator 280 (e.g., propane and gasoline), 110 VAC, 12 VDC deep cycle marine battery with solar panel recharge capability, and the ability to be plugged into a generator or vehicle for power. The RWS-DRIPS combines the best techniques for physical filtration and biofouling disinfection while being mobile. Its compact design allows for quick deployment to the field. The RWS-DRIPS unit (WOW cart in an embodiment) weighs less than 500 pounds, fits in the back of a pickup truck or trailer, and is considered a 2-person lift.

The RWS-DRIPS unit 240 includes the bleach generator and pumping system 250 and the gaseous chlorine generator 260. The gaseous chlorine generator 260 may be physically incorporated into the bleach generator and pumping system 250 in an alternative embodiment. The RWS-DRIPS unit 240 produces high strength gas-infused chlorination “bleach” to the container 270 and various dosing of the mixed solutions are pumped into each relief well. The bleach generator & pumping system 250 may include a pre-concentration storage of the bleach to establish high levels into the storage tank 270 in a pre-spike operation and to re-spike the tank 270 when needed via a flow line 290 with a flow line valve. The fluid can be recirculated from the storage tank 270 back to the pre-concentration storage of the bleach via a recirculation line 292 with a recirculation line valve, to adjust the chlorine concentration in the storage tank 270 to a desired level or to multiple desired levels over time to treat different wells. The gaseous chlorine generator 260 provides chlorine gas infusion into the chlorination bleach to achieve the desired chlorine concentration quickly of the field treating solution in the storage tank 270. An aqueous chlorine concentration of the field treating solution in the storage tank 270 may be adjusted by performing one or more of: adding water to the field treating solution in the storage tank 270 on-site; adding the liquid concentrated chlorine bleach to the field treating solution in the storage tank 270 on-site; adding the gaseous chlorine to the field treating solution in the storage tank 270 on-site; and recirculating the field treating solution from the storage tank 270 to the pre-concentration storage on-site. This can be used to achieve a preset nominally aqueous chlorine concentration for the field treating solution.

Upon various dosing experimentation in the laboratory and in the field environment, the team used pre-prepared liquid concentrated chlorine, well above 5 ppm, and placed 5 gallons into the pre-spiked 35-gallon container. Additional water from the relief well was added to the 35-gallon container to bring it up to at least 30 gallons. The gas infused chlorine generator 260 was turned on and established production of gas infused chlorine into the treatment train of the RWS-DRIPS unit 240. Upon adding an additional 950 gallons or close to 1000 gallons of source relief well water into the storage tank 270, the connecting hoses were opened to allow circulation of the pre-spike liquid chlorine water and the RWS-DRIPS gas infused circulating water. The 1000-gallon source water in the tank concurrently being treated started to build a high concentration of chlorine into the water. After a minimum of 2 hours, chlorine, closer to 5000 ppm were achieved and allowed for use of the treatment liquid to be used for each relief wells treatment process. Amounts of 50, 100, 300, 500 gallons were assessed for the most effective treatment of a relief well. The desired treatment amount is 50 gallons per relief well to maximize treatment of 20 relief wells with the 1000-gallon tank and RWS-DRIPS trailer unit.

The bleach generator and pumping system 250 provides high concentration bleach in the pre-concentration storage which can produce a flow of the high concentration bleach to pre-spike or re-spike the storage tank 270. The bleach generator and pumping system 250 may include a high concentration bleach generator to produce the liquid concentrated chlorine bleach on-site to a target bleach concentration.

### Methodology—High Concentration Bleach Generator

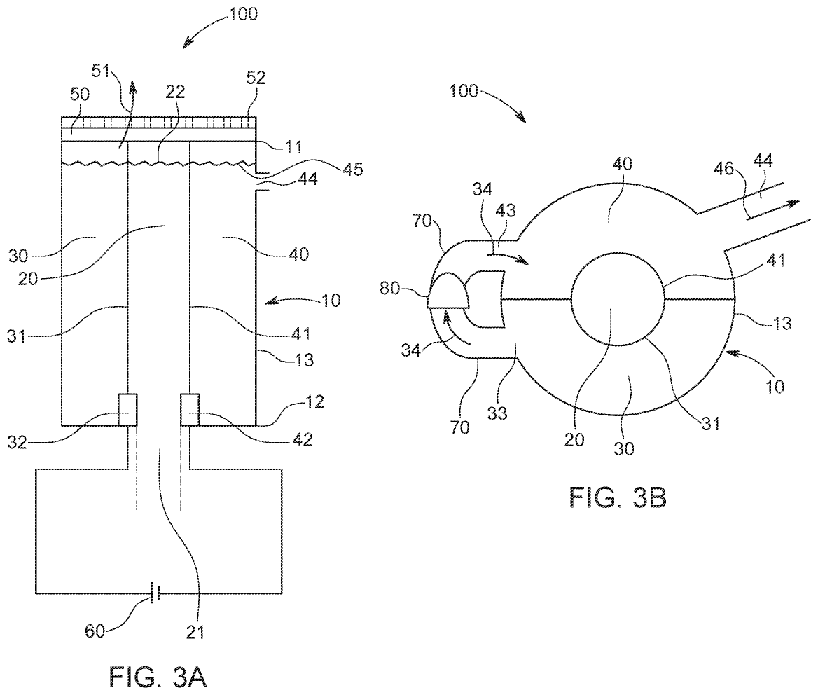

FIGS. 3A and 3B illustrate side and top schematic views, respectively, of an example of a high concentration bleach generator or a liquid concentrated chlorine bleach generator. The high concentration bleach generator 100 includes a housing 10, a brine chamber 20, an anionic chamber 30, a cationic chamber 40, a hydrogen selective membrane 50, an electrical power source 60, tubing 70 and a pump 80.

The housing 10 substantially encloses the brine chamber 20, anionic chamber 30, and cationic chamber 40. The housing 10 may be made of a lightweight, nonreactive material such as a polymer. The polymer may be translucent to allow for visual observation of bleach generation. The housing 10 has an upper end 11, a lower end 12, and a sidewall 13. In the embodiment shown, the hydrogen selective membrane 50 closes the upper end 11. In other embodiments, the hydrogen selective membrane 50 closes an aperture in the sidewall 13 or a portion of the upper end 11 above the cationic chamber 40.

In the embodiment shown, the brine chamber 20 is located within the housing 10, at least partially surrounded by the anionic chamber 30 and cationic chamber 40. The brine chamber 20 includes a brine inlet 21. The brine inlet 21 allows passage of additional brine 22 into the brine chamber 20. The brine 22 may be a solution of water and sodium chloride.

In the embodiment shown, the anionic chamber 30 includes an anionic exchange membrane 31, at least one anode electrode 32, an anionic chamber outlet 33, and a chlorine gas stream 34. The anionic exchange membrane 31 separates the brine chamber 20 from the anionic chamber 30 and selectively allows passage of negatively charged ions from the brine chamber 20 to the anionic chamber 30. These negatively charged ions may include, but are not limited to, chlorine ions.

The anode electrode 32 may be made from any suitably non-oxidizable and conductive material, such as steel, titanium, alloys or oxides thereof, or superconductors. The anode electrode 32 may also include a coating of a noble metal, including but not limited to platinum, palladium, gold, copper, silver, iridium, osmium, cadmium, indium, bismuth, tungsten, zirconium, alloys or oxides thereof, or any other suitable electrode material. In one embodiment, anode electrode 32 is made of noble metals, or alloys or oxides thereof.

The anode electrode 32 may have any suitable shape such as, but not limited to, flat plates, coaxial plates, rods, circular or spiral construction, or a combination thereof. The anode electrode 32 may have any suitable construction such as, but not limited to, a solid construction, a surface-patterned construction, or a non-solid construction with one or more apertures, such as a porous metallic mesh. In an embodiment shown, the anode electrode 32 is a highly interconnected, metallic foam-like structure. Such structures may have a surface area to volume ratio of approximately 100:1 to approximately 1,000,000:1.

In the embodiment shown, the anionic chamber outlet 33 permits operative connection of the cationic chamber 40 and anionic chamber 30, allowing the chlorine gas stream 34 to flow from the anionic chamber 30 to the cationic chamber 40. The cationic chamber 40 includes a cationic exchange membrane 41, at least one cathode electrode 42, a cationic chamber inlet 43, a cationic chamber outlet 44, an alkali and alkaline hydroxide mass 45, and a bleach stream 46. The cationic exchange membrane 41 separates the brine chamber 20 from the cationic chamber 40 and selectively allows passage of positively charged ions from the brine chamber 20 to the cationic chamber 40. These positively charged ions may include, but are not limited to, sodium ions. These positively charged ions form the alkali and alkaline hydroxide mass 45.

The cathode electrode 42 may be made from any suitably non-reducible and conductive material, such as steel, titanium, alloys or oxides thereof, or superconductors. The cathode electrode 42 may also include a coating of a noble metal, including but not limited to platinum, palladium, gold, copper, silver, iridium, osmium, cadmium, indium, bismuth, tungsten, zirconium, alloys or oxides thereof, or any other suitable electrode material. In one embodiment, the cathode electrode 42 is made of noble metals, or alloys or oxides thereof.

The cathode electrode 42 may have any suitable shape, such as, but not limited to flat plates, coaxial plates, rods, circular or spiral construction, or a combination thereof. The cathode electrode 42 may have any suitable construction such as, but not limited to, a solid construction or a surface-patterned construction, or can have one or more apertures, such as a porous metallic mesh. In one embodiment, the cathode electrode 42 is a highly interconnected, metallic foam-like structure. Such structures may have a surface to volume area ratio of approximately 100:1 to approximately 1,000, 000:1.

The cationic chamber inlet 43 operatively connects the cationic chamber 40 and the anionic chamber 30, allowing influx of the chlorine gas stream 34 from the anionic chamber 30. Combination of the chlorine gas stream 34 with the alkali and alkaline hydroxide mass 45 in the cationic chamber 40 creates the bleach stream 46. The cationic chamber outlet 44 permits passage of the bleach stream 46 out of the housing 10 and the cationic chamber 40.

The hydrogen removal membrane 50 allows the hydrogen gas stream 51 to selectively diffuse out of the high concentration bleach generator 100 into the atmosphere or other containment and/or treatment systems. In the embodiment shown, the hydrogen selective membrane 50 closes the upper end 11 of the housing 10. The hydrogen selective membrane 50 may be a sulfonated tetrafluoroethylene-based fluoropolymer-copolymer.

The hydrogen selective membrane 50 performs membrane gas separation at pressures less than or equal to approximately 14 psig. As a result, the hydrogen selective membrane 50 has a tensile strength of greater than or equal to approximately 14 psi. Within the high concentration bleach generator 100, the chlorine gas stream 34 and hydrogen gas stream 51 are present as a mixture of gases. In a mixture of gases, each gas has a partial pressure that is the hypothetical pressure of that gas if it alone occupied the volume of the mixture at the same temperature. The total pressure of an ideal gas mixture is the sum of the partial pressures of each individual gas in the mixture. The pressure of the hydrogen gas stream 51 ranges from approximately 5 percent to approximately 6 percent of the total gas pressure within the high concentration bleach generator 100. The pressure of the chlorine gas stream 34 ranges from approximately 94 percent to approximately 95 percent of the total gas pressure. Additional reaction gaseous byproducts, such as oxygen (0₂) and hydrogen chloride (HCl) may form a partial pressure of approximately 0 percent to approximately 1 percent of the total gas pressure within the high concentration bleach generator 100.

In the embodiment shown, a membrane cover 52 secures the hydrogen selective membrane 50 to the housing 10 and increases the pressure that may be applied to the hydrogen selective membrane 50. The membrane cover 52 has an apertured, woven, lattice, or mesh configuration allowing escape of the hydrogen gas stream 51.

The electrical power source 60 electrically connects to the anode electrode 32 and cathode electrode 42 at opposite terminals. The electrical power source 60 can provide a constant DC output voltage, a pulsed or otherwise modulated DC output voltage, or a pulsed or otherwise modulated AC output voltage to the anode electrode 32 and cathode electrode 42. In the embodiment shown, the voltage of the electrical power source 60 ranges from approximately 3 V to approximately 24 V with presently existing electrodes; however, as newer electrode technology develops, the voltage range could be lower. Other embodiments may use voltages of up to approximately 120 V. Altering the applied voltage controls the rate of production of the chlorine gas stream 34 generated in the anionic chamber 30. The tubing 70 interconnects the anionic chamber outlet 33, the pump 80, and the cationic chamber inlet 43. The pump 80 pumps the chlorine gas stream 34 from the anionic chamber outlet 33 to the cationic chamber inlet 43. Additional details of the high concentration bleach generator 100 can be found in U.S. Pat. No. 10,077,197, which is incorporated herein by reference in its entirety.

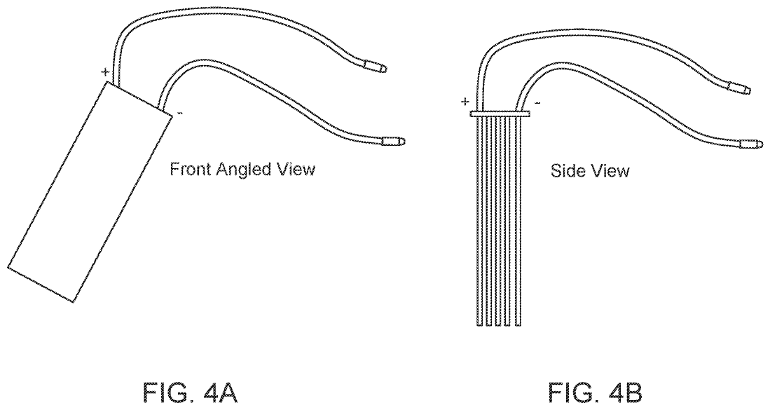

FIG. 4A shows a front angled view and FIG. 4B shows a side view, as an alternative embodiment, of a chlorine generator probe used to produce a concentrated chlorine solution of approximately 5000 mg CI/L. More specifically, 445 g of sodium chloride (NaCl) is solubilized in 5 L of deionized (DI) water. The CI generator probe is a portable unit that can be powered via direct or alternating current.

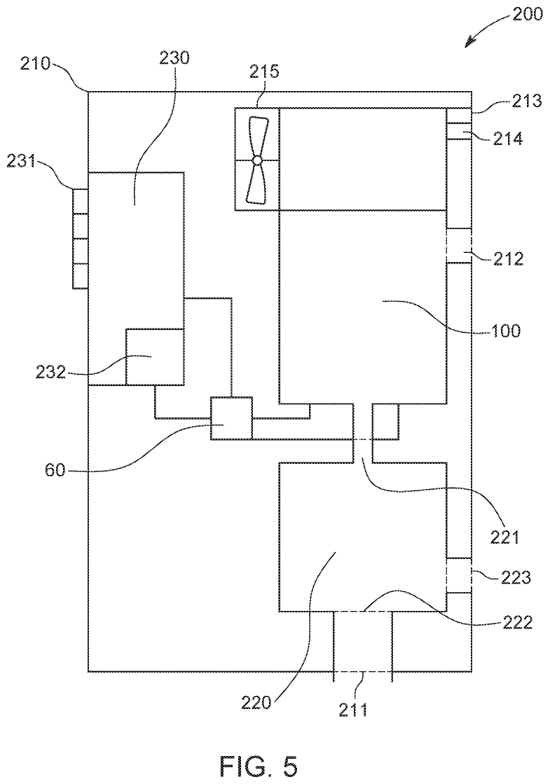

FIG. 5 is a schematic view illustrating an example of a high concentration bleach generator system. The high concentration bleach generator system 200 includes at least one high concentration bleach generator 100, a system housing 210, at least one brine reservoir 220, and a data processor 230.

The system housing 210 substantially encloses the high concentration bleach generator 100 and at least one brine reservoir 220. In the embodiment shown, the system housing 210 also encloses at least part of a data processor 230. The system housing 210 includes at least one reservoir port 211 operatively coupled to the brine reservoir 220 to allow refilling of the brine reservoir 220. The system housing 210 also includes at least one bleach port 212 operatively coupled to the cationic chamber outlet 44 to allow a user to draw off the bleach stream 46. The system housing 210 includes at least one hydrogen vent 213 for venting off the hydrogen gas stream 51. In the embodiment shown, the hydrogen vent 213 includes a one-way 55 valve 214 to prevent hydrogen from reentering the system housing 210. Optionally, the system housing 210 further includes a fan 216 exhausting the hydrogen gas stream 51.

The brine reservoir 220 contains additional brine 22 and operatively connects to the brine inlet 21 at a reservoir outlet port 221, allowing passage of additional brine 22 into the brine chamber 20. The brine reservoir 220 includes at least one fill port 222 operatively coupled to the reservoir port 211 and at least one equalization port 223 open to the atmosphere, preventing formation of a vacuum. The brine reservoir 220 has a maximum capacity of approximately 2 L to approximately 4 L, which is approximately 2 to 3 times the size of the brine chamber 20. The rate of bleach production is proportional to the voltage, brine salt content, and time, and is inversely proportional to temperature. Materials forming the brine reservoir 220 include, but are not limited to, polymers, titanium, and other non-corroding materials.

The data processor 230 includes a user interface 231 and a timer 232. In use, a user may enter a desired bleach concentration on the user interface 231. The data processor 230 is configured with software that calculates and transmits to the timer 232 the amount of time required to produce such a bleach concentration using at least one high concentration bleach generator 100. The timer 232 operatively interconnects the electrical power source 60 to the high concentration bleach generator 100, providing electrical power to the high concentration bleach generator 100 for the given amount of time necessary to generate the desired bleach concentration. The data processor 230 is further configured with software that calculates and controls the voltage of the electrical power source 60 based on the desired bleach concentration.

U.S. Pat. No. 10,487,409, which is incorporated herein by reference in its entirety, discloses an example of a high concentration bleach generator system for producing chlorine bleach. A container holds a solution of water and salt. An electrolysis apparatus includes an anode plate, a cathode plate, one or more inner conductive plates between the anode plate and the cathode plate, and a sleeve surrounding the plates. A power source has a first terminal connected to the anode plate and a second terminal connected to the cathode plate. The electrolysis apparatus is inserted into the solution. One or more combs may be attached to at least one of the anode plate, the cathode plate, and the one or more inner conductive plates, each of the one or more combs positioned and extending between the anode plate and the cathode plate, thus maintaining spacing between the anode plate, the cathode plate, and the one or more inner conductive plates. One or more posts may each extend through respective openings defined through each of the anode plate, the cathode plate, and the one or more inner conductive plates. The plates may all extend in a first direction from a first end to a second end, while the sleeve includes a sidewall that defines a plurality of openings configured to allow the solution to enter the sleeve in a second direction that is substantially perpendicular to the first direction.

In other embodiments, the WOW RWS 240 includes container(s) of the high concentration bleach prepared offsite in advance, in addition to or instead of the high concentration bleach generator 100 for producing the high concentration bleach onsite. One feature of the bleach generator and pumping system 250 is to pre-spike and/or re-spike the field treating solution quickly to a sufficiently high chlorine concentration for treatment use. Having premade high concentration bleach ready for onsite use can ensure or improve the time-saving feature of the system.

### Methodology—Chlorine Demand Test

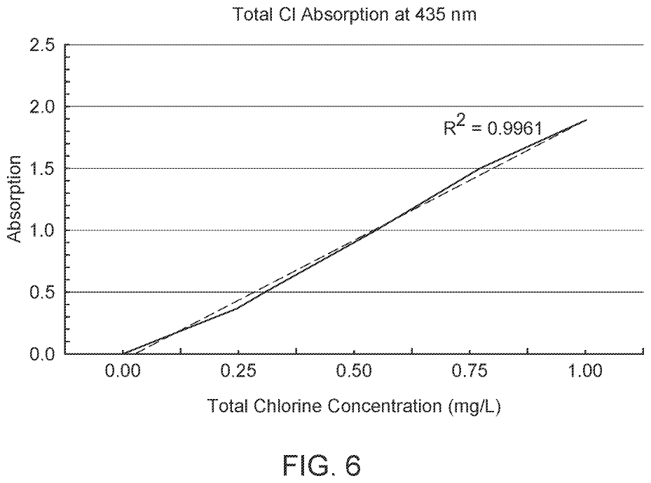

FIG. 6 is a graphical plot of an example of a calibration curve of absorption versus total chlorine concentration. The calibration curve is generated using a colorimetric method to produce colorimetric range for chlorine (CI) measurement of CI solutions between 0 and 1 mg/L. The CI concentrations above 1 ppm cannot be accurately measured at 435 nm. CI standards are measured at a wavelength of 435 nm as this is the maximum absorption for secondary oxidation products of orthotolidine (OTO). Orthotolidine color indicator is used for the detection of total available Cl.

Samples collected from a relief well (RW) was used in this investigation. The RW sample consisted of an iron (Fe) biofilm highly visible in the solution. Chlorine at concentrations between 0 and 1.5 mg/L were evaluated in RW samples. Total sample volumes of 50 mL were tested. All samples were prefiltered to remove the Fe Biofilm to prevent absorption interference. DI water used for unamended control samples and CI concentration adjustments was sterilized (autoclaved at 121° C. for 20 minutes).

To understand effective treatment of Chlorine (CI), a total CI absorption curve was created to show the potential concentration measurements that would be used with field water source water samples containing microbiological based biofilms retrieved from relief wells.

### Results in Lab—Chlorine Demand

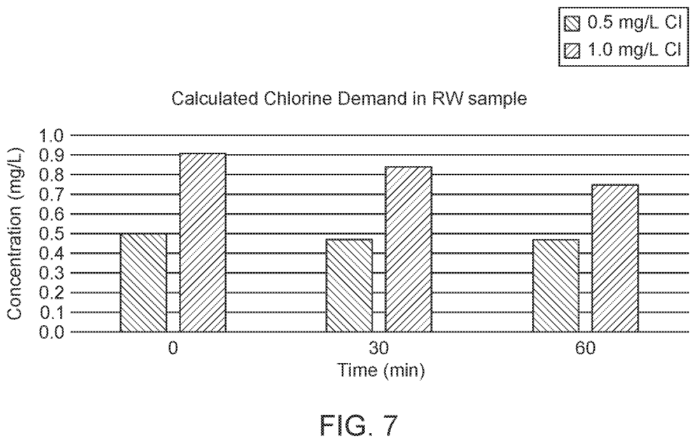

FIG. 7 is a graphical plot of an example of calculated chlorine demand in a relief well (RW) sample in the laboratory. It shows the estimated CI concentrations consumed by bacteria in RW samples in samples amended at 0.5 and 1.0 mg CI/L. Chlorine was consumed in samples amended at 0.5 mg/L almost entirely, whereas residual CI in samples amended to 1.0 mg/L was calculated at approximately 1 mg/L. The calculated concentrations of chlorine consumed by bacteria in RW samples is determined using the calibration curve. These values are obtained by subtracting the Abs value of CI in RW samples from the Abs value of CI in water for each concentration evaluated. The variability in CI consumption over time is likely attributed to difference in required residence time for the bacterial species present.

In assessing the CI levels with the relief well source water field samples collected, the team began investigating the exposure times in half hour-to-hour increments with two doses of CI concentration to understand initially how much CI was necessary for an amount of time to be effective for degradation of the biofilm present in the source water sample. The research team assessed the contact time of CI to biofilm to be effective and build upon the knowledge for effective field treatment regimens later in the field studies.

Results from the Field

The RWS-DRIPS unit was used to conduct biofouling treatment operations on a number of relief wells that required their 5-year cycled treatment from biofilm growth within the relief wells. The research team conducted a treatment plan on each well with various concentrations and liquid volumes of high strength gas-infused chlorination “bleach” generation for necessary water treatment. If left untreated, unwanted pressure can build up in the levee causing points of frailer and stress within the levee. The team also collected water samples pre and post treatments for bacterial investigation, measured concentrations of chlorination production, and evaluated the use of high-powered UV light source to the well pre and post treatments to study effectiveness of UV exposures to the biofilms and relief wells.

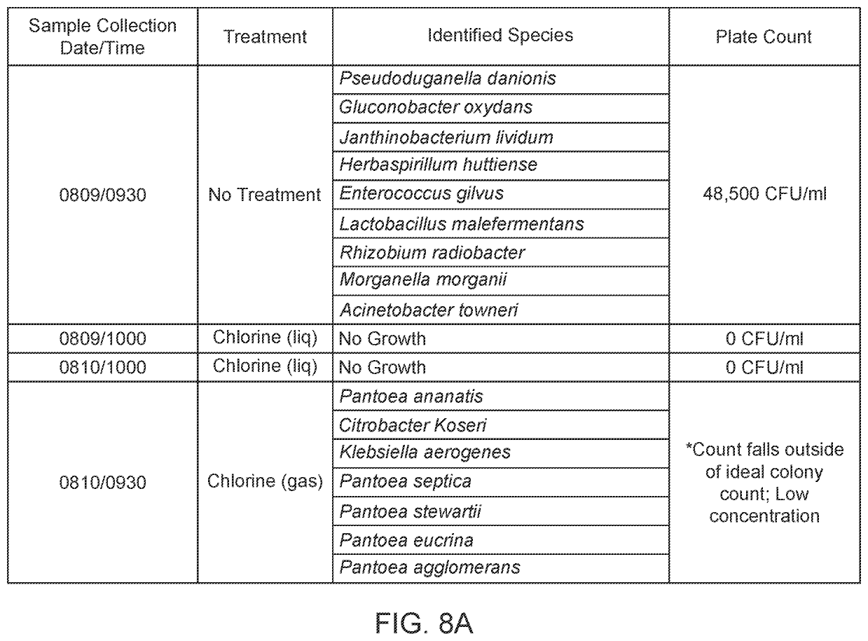

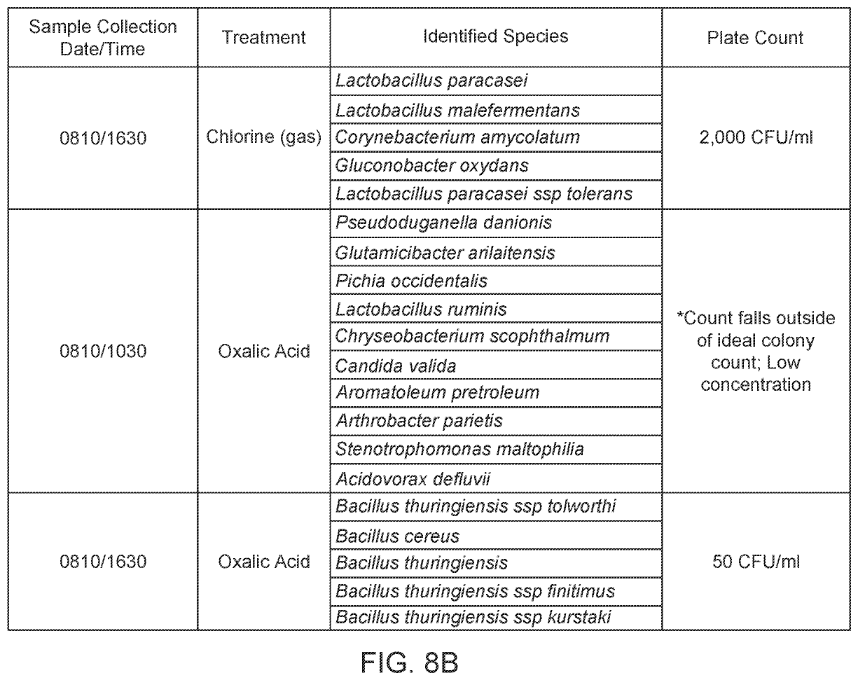

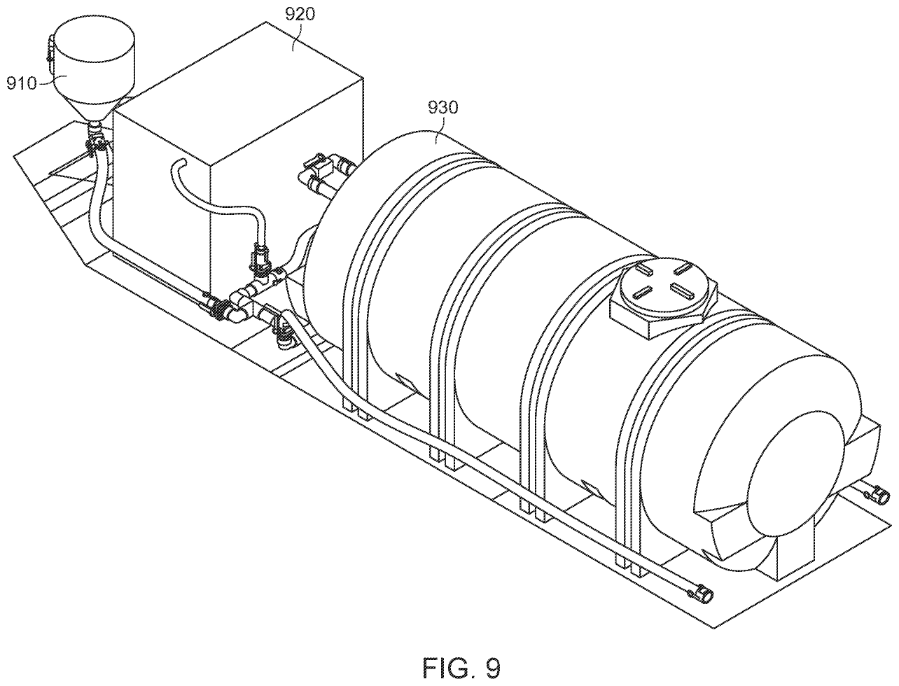

FIGS. 8A and 8B show a table of results from the field. Relief well water samples were collected and measurements made in the laboratory. The tables show data from relief well source water with no treatment and with treatments. Treatments included liquid chlorine concentrated and gas infused chlorine concentrates. Samples were collected in the morning and afternoon and sometimes mid-day. The samples were plated on microbial growth plates in the laboratory and allow incubation times for colony growth to form. Post growth measurements collected colony forming units or number of colonies and/or if there were no growth or some grow but low concentrations. This information allows the research team to gage for treatment of the relief wells to various dosing of the CI or Oxalic Acid comparisons of what was currently used as a treatment to what was new regarding the liquid or gas infused chlorine concentrations the team was using.

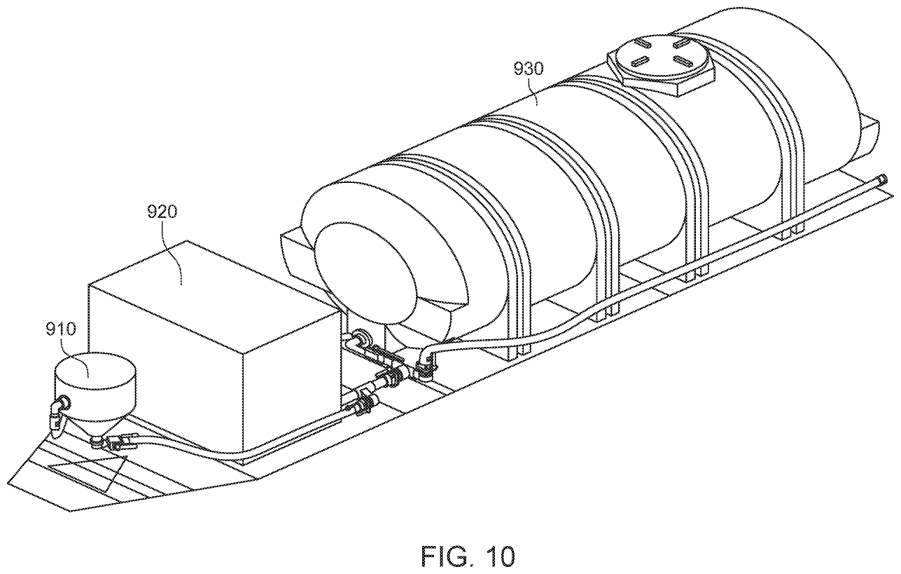

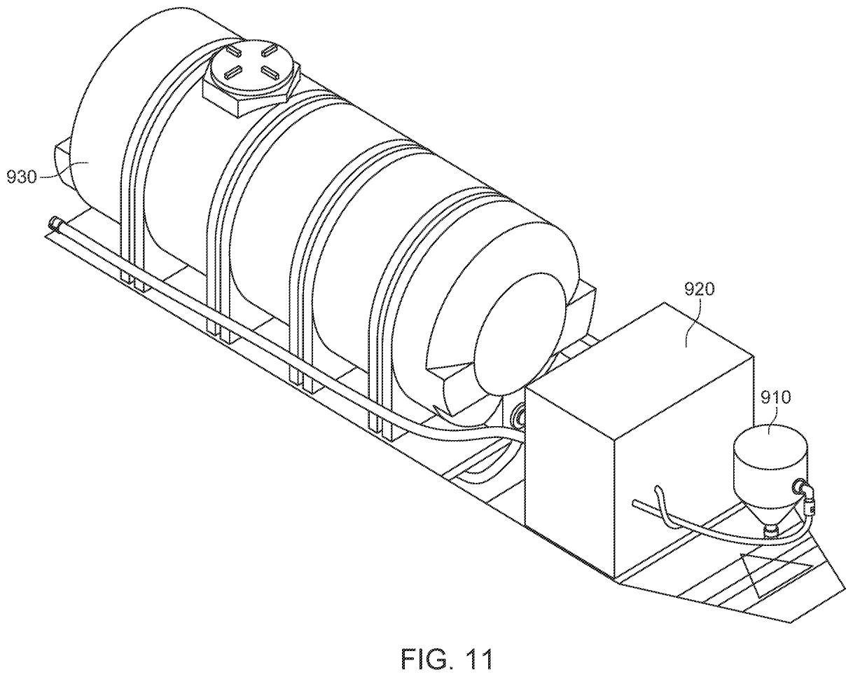

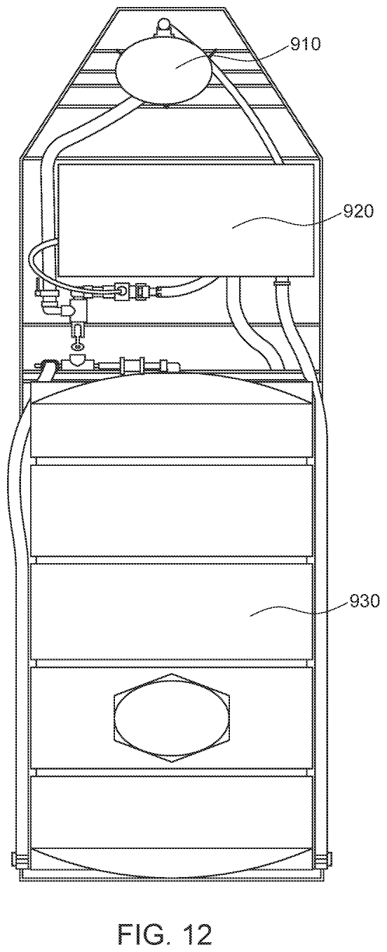

FIG. 9 is a rendered model of an RWS-DRIPS trailer unit. FIG. 10 is another perspective view thereof. FIG. 11 is another perspective view thereof. FIG. 12 is a top plan view thereof. A pre-spiked high concentration container 910 holds liquid sodium hyperchlorite or chlorine bleach solution above 5 ppm. An RWS-DRIPS unit 920 (embedded WOW cart) includes an electrochlorination unit and pumps comprised of treatment train plumping. The hoses interconnect all units and containers leading to a 1000-gallon tank 930 with pumps and hoses for mixing. The RWS-DRIPS unit 920 includes a gaseous chlorine generator for generating the gas infused chlorine bleach into solution with pumped in relief well or well water. The resulting high strength combined liquid and gas infused chlorine bleach solution is used for treatment of the relief wells.

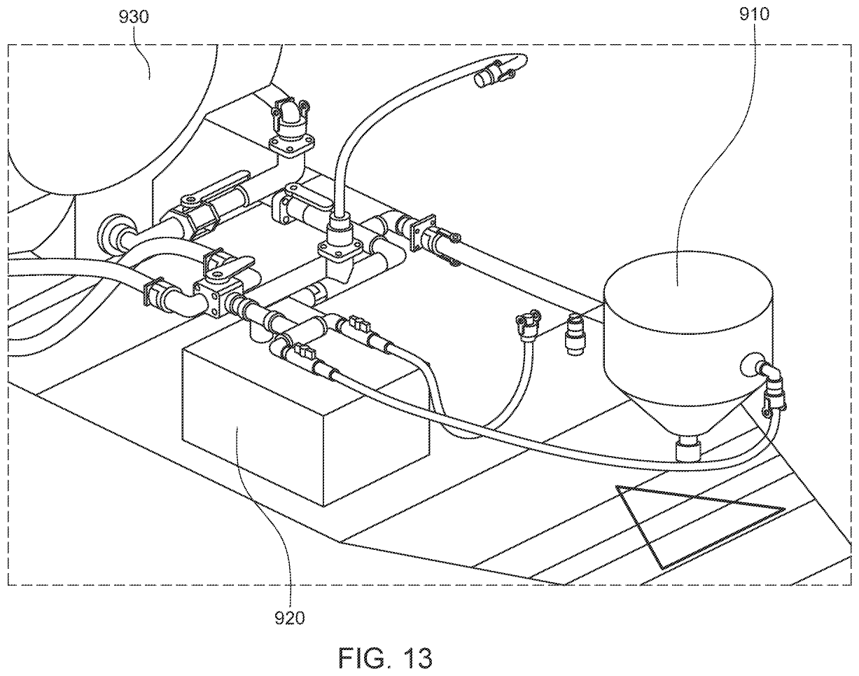

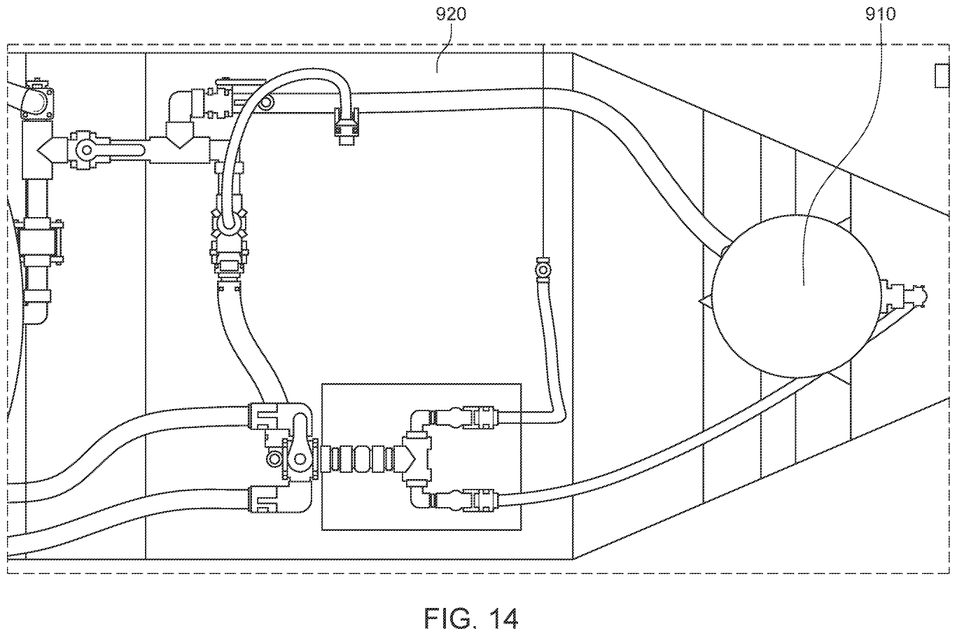

FIG. 13 is a close-up perspective view of the rendered model of the RWS-DRIPS unit 920 illustrating the electrochlorination treatment train and pumps with hose connections to the pre-spike concentration container 910 and the 1000-gallon tank 930. FIG. 14 is a close-up top plan view thereof.

### Methodology—Process for Treating Biofouling in a Relief Well

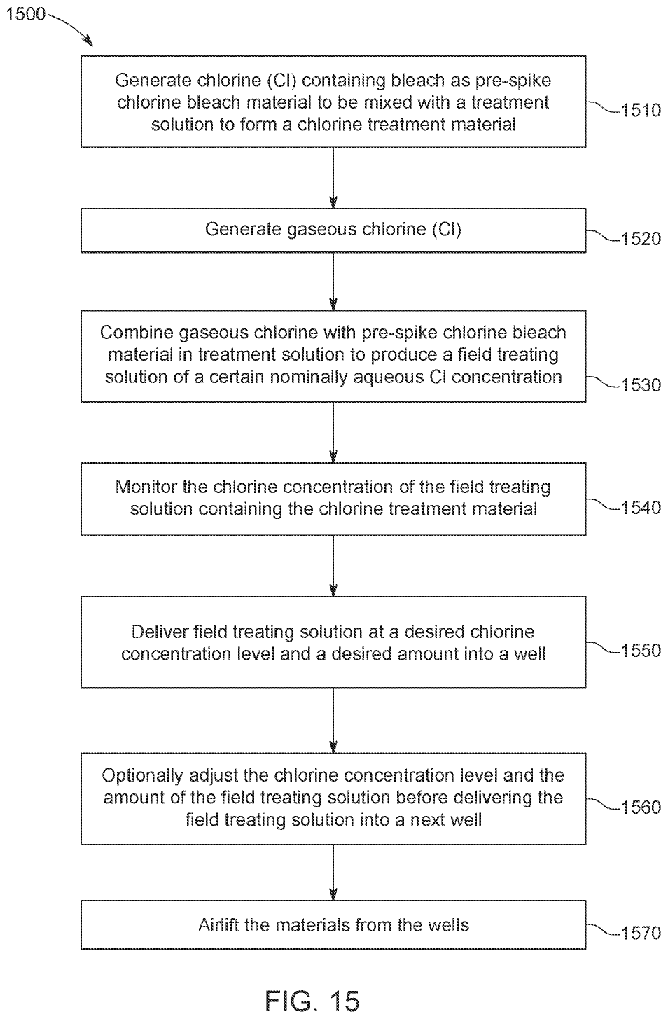

FIG. 15 is a flow diagram illustrating an example of a process 1500 for treating biofouling in a relief well. In step 1510, the system generates chlorine (CI) containing bleach as pre-spike chlorine bleach material, e.g., by applying electric energy to an ionic source of chlorine such as dry salt and water. The high concentration chlorine bleach or liquid concentrated chlorine bleach is used to pre-spike a treatment solution (e.g., water). Step 1520 generates gaseous chlorine (CI). Step 1530 combines the pre-spike chlorine bleach material with the gaseous chlorine as a topper to produce a field treating solution of a certain nominally aqueous CI concentration (e.g., nominally 5000 ppm).

Step 1540 involves monitoring the chlorine concentration of the field treating solution containing the chlorine treatment material. Step 1550 includes delivering the field treating solution containing the chlorine treatment material at a desired chlorine concentration level (e.g., a preset aqueous chlorine concentration) and a desired amount into a well. The desired amount and chlorine concentration of the field treating solution delivered may be determined by the size and/or condition of the wells. In embodiments, about 50 gallons of field treating solution may be delivered to each well. The chlorine concentration may be adjusted (e.g., by recirculating the solution between the pre-concentration storage of the RWS-DRIPS unit and the storage tank 270) before delivering the field treating solution containing the chlorine treatment material to each well.

Step 1560 involves optionally adjusting the chlorine concentration level and the amount of the field treating solution before delivering the field treating solution containing the chlorine treatment material into a next well. The field treating solution is left in the wells for a period of time (e.g., overnight) in step 1570. Step 1580 involves an airlifting the materials from the wells by pumping the materials out of the wells.

The present approach substitutes a chlorine-based treatment for an acid-based treatment. The chlorine-based treatment has two components. The first involves a “kick start” step to “pre-spike” the field treating solution by taking for the basic chlorine charge the output of a device that takes an ionic source of chlorine (such as dry salt) and applying electric energy (with water) to generate a chlorine containing bleach. The second involves a “topping” step to add as a “topper” a gaseous chlorine output (e.g., from an off-the-shelf device such as the M-100) to the chlorine containing bleach to produce the desired endpoint of nominally 5,000 ppm aqueous chlorine concentration. This unique approach both (i) attains the 5,000 ppm+ level and (ii) achieves that level so far more quickly than previously possible.

The method combines the “pre-spike” chlorine bleach materials obtained from salt and the “topper” chlorine gaseous materials from the COTS (commercial-off-the-shelf) M−100 unit to obtain 1,000 gals of 5,000 ppm chlorine treatment materials in a short period of time and on location. The result is an amount that may be sufficient to treat 15-20 (or more) relief wells without having to recharge the 1,000-gal treatment tank. For example, the chlorine treatment materials may be ready for treatment use within about 0-4 hours instead of 5 hours or more. In specific embodiments, the time to prepare the chlorine treatment materials may be shortened to about 0-3 hours or 0-2 hours.

One objective of the present invention is to field generate 1,000 gals of chlorine-based well treatment material good for treatment of on the order of at least 15-20 relief wells without stopping at 2-3 well intervals to remix (as the old acid-based method requires). The novel field treatment method achieves the objective by combining the “kick start” and “topping” steps that drastically reduces the time, expense, labor, etc.

As will be appreciated by one of ordinary skill in the art, the present invention may be embodied as an apparatus (including, for example, a system, a machine, a device, and/or the like), as a method (including, for example, a business process, and/or the like), as a computer-readable storage medium, or as any combination of the foregoing.

The present well cleaning system and method may be desirable to any government or commercial entity that manages groundwater wells (levee or dam relief wells, monitoring wells, etc.). Government agencies that may have particular interest are USACE (levee and dam relief wells, monitoring wells), EPA (monitoring wells, in-situ remediation wells), DOE (monitoring wells), and USGS (monitoring wells). Commercial entities that sell well-cleaning services to private customers or municipalities may also benefit from the present invention.

The inventive concepts taught by way of the examples discussed above are amenable to modification, rearrangement, and embodiment in several ways. Accordingly, although the present disclosure has been described with reference to specific embodiments and examples, persons skilled in the art will recognize that changes may be made in form and detail without departing from the spirit and scope of the disclosure.

An interpretation under 35 U.S.C. § 112 (f) is desired only where this description and/or the claims use specific terminology historically recognized to invoke the benefit of interpretation, such as “means,” and the structure corresponding to a recited function, to include the equivalents thereof, as permitted to the fullest extent of the law and this written description, may include the disclosure, the accompanying claims, and the drawings, as they would be understood by one of skill in the art.

To the extent the subject matter has been described in language specific to structural features and/or methodological steps, it is to be understood that the subject matter defined in the appended claims is not necessarily limited to the specific features or steps described. Rather, the specific features and steps are disclosed as example forms of implementing the claimed subject matter. To the extent headings are used, they are provided for the convenience of the reader and are not to be taken as limiting or restricting the systems, techniques, approaches, methods, devices to those appearing in any section. Rather, the teachings and disclosures herein can be combined, rearranged, with other portions of this disclosure and the knowledge of one of ordinary skill in the art. It is the intention of this disclosure to encompass and include such variation.

The indication of any elements or steps as “optional” does not indicate that all other or any other elements or steps are mandatory. The claims define the invention and form part of the specification. Limitations from the written description are not to be read into the claims.

Embodiments of the invention can be manifest in the form of methods and apparatuses for practicing those methods. As compared to traditional manual process of rehabilitating a well affected by fouling, the benefits of implementing this technology include continuous and autonomous treatment and prevention, eliminating potential danger to personnel, preventing recolonization or regrowth, and significantly reducing the cost.

Unless explicitly stated otherwise, each numerical value and range should be interpreted as being approximate as if the word “about” or “approximately” preceded the value or range.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

All documents mentioned herein are hereby incorporated by reference in their entirety or alternatively to provide the disclosure for which they were specifically relied upon.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. A method for treating one or more wells, the method comprising:
combining a liquid concentrated chlorine bleach with water on-site at the one or more wells;
generating gaseous chlorine on-site;
adding the gaseous chlorine into the water combined with the liquid concentrated chlorine bleach to produce a field treating solution on-site; and
delivering the field treating solution into the one or more wells.

2. The method of claim 1, further comprising:
providing the liquid concentrated chlorine bleach in a pre-concentration storage on-site; and
flowing the liquid concentrated chlorine bleach from the pre-concentration storage to a storage tank to be combined with the water in the storage tank.

3. The method of claim 2, wherein at least some of the liquid concentrated chlorine bleach is prepared offsite in advance, the method further comprising:
bringing the liquid concentrated chlorine prepared offsite to the one or more wells to be combined with the water on-site.

4. The method of claim 2, further comprising:
producing, on-site, at least some of the liquid concentrated chlorine bleach which is to be combined with the water on-site.

5. The method of claim 4,
wherein at least some of the liquid concentrated chlorine bleach is produced by applying electric energy to an ionic source of chlorine and water on-site.

6. The method of claim 2, further comprising:
adding the gaseous chlorine into the water combined with the liquid concentrated chlorine bleach to produce the field treating solution on-site at a preset nominally aqueous chlorine concentration before delivering the field treating solution into the one or more wells.

7. The method of claim 6, further comprising:
recirculating the field treating solution from the storage tank to the pre-concentration storage on-site to adjust the nominally aqueous chlorine concentration of the field treating solution in the storage tank to achieve the preset nominally aqueous chlorine concentration.

8. The method of claim 2, further comprising, after delivering the field treating solution into one well of the one or more wells and before delivering the field treating solution into another well of the one or more wells, adjusting the nominally aqueous chlorine concentration of the field treating solution in the storage tank by performing at least one of:
adding water to the field treating solution in the storage tank on-site;
adding the liquid concentrated chlorine bleach to the field treating solution in the storage tank on-site;
adding the gaseous chlorine to the field treating solution in the storage tank on-site; or
recirculating the field treating solution from the storage tank to the pre-concentration storage on-site.

9. The method of claim 1, further comprising:
monitoring an aqueous chlorine concentration of the field treating solution until a preset aqueous chlorine concentration is reached before delivering the field treating solution into the one or more wells.

10. A method for treating one or more wells, the method comprising:
providing a liquid concentrated chlorine bleach in a pre-concentration storage on-site at the one or more wells;
combining the liquid concentrated chlorine bleach from the pre-concentration storage with water in a storage tank on-site;
generating gaseous chlorine on-site;
adding the gaseous chlorine into the water combined with the liquid concentrated chlorine bleach in the storage tank to produce a field treating solution on-site; and
delivering the field treating solution into the one or more wells.

11. The method of claim 10, further comprising, before delivering the field treating solution into a well of the one or more wells, adjusting an aqueous chlorine concentration of the field treating solution in the storage tank by performing at least one of:
adding water to the field treating solution in the storage tank on-site;
adding the liquid concentrated chlorine bleach to the field treating solution in the storage tank on-site;
adding the gaseous chlorine to the field treating solution in the storage tank on-site; or
recirculating the field treating solution from the storage tank to the pre-concentration storage on-site.

12. The method of claim 10, wherein at least some of the liquid concentrated chlorine bleach is prepared offsite in advance, the method further comprising:
bringing the liquid concentrated chlorine prepared offsite to the one or more wells to be combined with the water on-site.

13. The method of claim 10, further comprising:
producing, on-site, at least some of the liquid concentrated chlorine bleach which is to be combined with the water on-site.

14. The method of claim 13,
wherein at least some of the liquid concentrated chlorine bleach is produced by applying electric energy to an ionic source of chlorine and water on-site.

15. A system for treating one or more wells, the system comprising:
a supply of a liquid concentrated chlorine bleach on-site at the one or more wells;
a gaseous chlorine generator to generate gaseous chlorine on-site;
a storage tank; and
a plumbing system to flow the liquid concentrated chlorine bleach from the supply of the liquid concentrated chlorine bleach and the gaseous chlorine from the gaseous chlorine generator to the storage tank to be combined with water in the storage tank on-site, to produce a field treating solution on-site to be delivered into the one or more wells.

16. The system of claim 15, further comprising:
a pre-concentration storage to store the liquid concentrated chlorine bleach on-site;
wherein the plumbing system is coupled with the pre-concentration storage to flow the liquid concentrated chlorine bleach from the pre-concentration storage to the storage tank on-site.

17. The system of claim 16, further comprising:
a recirculation flow line configured to recirculate the field treating solution from the storage tank to the pre-concentration storage on-site to adjust an aqueous chlorine concentration of the field treating solution in the storage tank.

18. The system of claim 17, further comprising:
a liquid concentrated chlorine bleach generator to produce the liquid concentrated chlorine bleach on-site to a target bleach concentration; and
a data processor configured with software that calculates and controls an energy power level to operate the liquid concentrated chlorine bleach generator based on the target bleach concentration.

19. The system of claim 15, further comprising at least one of:
one or more containers which contain the liquid concentrated chlorine bleach prepared offsite and are brought on-site; or
a liquid concentrated chlorine bleach generator to produce the liquid concentrated chlorine bleach on-site.

20. The system of claim 19,
wherein the liquid concentrated chlorine bleach generator is configured to produce at least some of the liquid concentrated chlorine bleach by applying electric energy to an ionic source of chlorine and water on-site.
